(19) United States
(12) Patent Application Publication
(10) Pub. No.: US 2010/0092715 A1
(43) Pub. Date: Apr. 15, 2010

(54) ANTI-SQUEAK TAPE, AND METHODS OF FABRICATING AND UTILIZING SAME

(76) Inventor: CHRISTOPHER S. AUTTERSON, Novi, MI (US)

Correspondence Address: WEINER & BURT, P.C., 635 N US-23, POB 186, HARRISVILLE, MI, 48740, US

(21) Appl. No.: 12/250,122

(22) Filed: Oct. 13, 2008

(51) Int. Cl. B32B 7/10; B32B 27/08

(52) U.S. Cl. 428/41.8; 428/516; 428/517; 428/340

(57) ABSTRACT

An anti-squeak tape having a first film layer of high density polyethylene material or high molecular weight high density polyethylene material; and a second film layer comprising an acrylic or rubber based adhesive material.

### CROSS-REFERENCE TO RELATED APPLICATIONS

Not Applicable

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The term “HDPE” as used herein means high density polyethylene.

The term “HWMHDPE” as used herein means high molecular weight high density polyethylene

The present invention relates to a novel and unique anti-squeak tape, and methods of fabricating and utilizing same.

More particularly, the present invention relates to an anti-squeak tape using a HDPE or HMWHDPE material, and methods of fabricating and utilizing same.

In various industries, including the automotive industry, it is desirable to eliminate squeaks and other noise generated between contacting components and/or surfaces thereof.

The prior, but not necessarily relevant, art is exemplified by:

Malhotra U.S. Pat. No. 5,793,003;

Smoot U.S. Pat. No. 5,940,139;

Clerici et al. U.S. Pat. No. 6,022,623; and

Arthurs United States Patent Application Publication 2006/0276091.

The present invention solves the aforementioned problems and other problems, and also provides an anti-squeak tape which can be used full-time under all types of conditions.

It is a desideratum of the present invention to avoid the animadversions of the conventional and present techniques and tapes, and to provide a very efficient and relatively-inexpensive anti-squeak tape.

### SUMMARY OF THE INVENTION

The present invention provides an anti-squeak tape, comprising: a first film layer comprising a polyethylene material; and a second film layer comprising an acrylic or rubber based adhesive material.

The present invention also provides an anti-squeak tape which, in one embodiment, includes a HDPE or HMWHDPE film, an acrylic or rubber based adhesive, and a release liner

The present invention also provides an anti-squeak tape which includes a HDPE or HMWHDPE film with a release coating, and acrylic or rubber based adhesive material.

It is a primary object of the present invention to provide a novel sound-reducing or anti-squeak tape, as described hereinbelow, which includes HDPE or HMWHDPE.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a perspective view illustrating how noise is generated when two mating surfaces come into contact with each other.

FIG. 2 is a perspective view showing how an HDPE or HMWHDPE tape bonds with acrylic or rubber based adhesive to one of the surfaces as depicted in FIG. 1.

FIG. 3 is a perspective view showing how surface contact noise is eliminated when the HDPE or HMWHDPE tape is used.

FIG. 4 is a perspective view of a first embodiment of the present invention.

FIG. 5 is a perspective view of a second embodiment of the present invention.

### DETAILED DESCRIPTION OF THE INVENTION

HDPE is defined by a density of greater or equal to 0.941 g/cc³.

HMWHDPE is defined by a density of greater or equal to 0.947 g/cc³ within the same molecular makeup.

HDPE has a low degree of branching and thus stronger intermolecular forces and tensile strength. HMWHDPE has even less branching within the same molecular chain as HDPE creating an even stronger film.

HDPE and HMWHDPE can be produced by chromium/silica catalysts, Ziegler-Natta catalysts or metallocene catalysts.

The lack of branching is ensured by an appropriate choice of catalyst (e.g. Chromium catalysts or Ziegler-Natta catalysts) and reaction conditions.

HDPE is used in products and packaging such as milk jugs, detergent bottles, margarine tubs, and garbage containers. HMWHDPE is used in similar products where additional toughness is required.

HMWHDPE has better abrasion resistance, higher tensile strength at yield than HDPE.

In addition, HMWHDPE is closer than HDPE in performance characteristics to ultra high molecular weight polyethylene.

HDPE and HMWHDPE meet the physical and performance requirements for automobiles and various other equipment and devices.

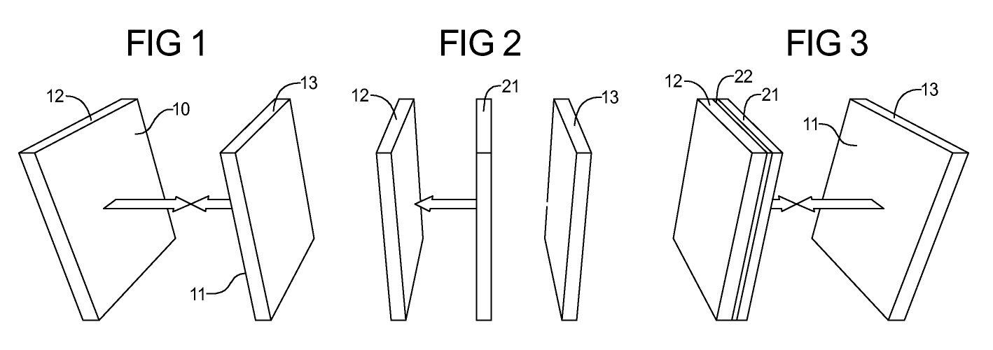

With reference to FIG. 1, when two mating surfaces 10 and 11 of components 12 and 13, respectively, come into contact with each other, squeaks or other noise is generated.

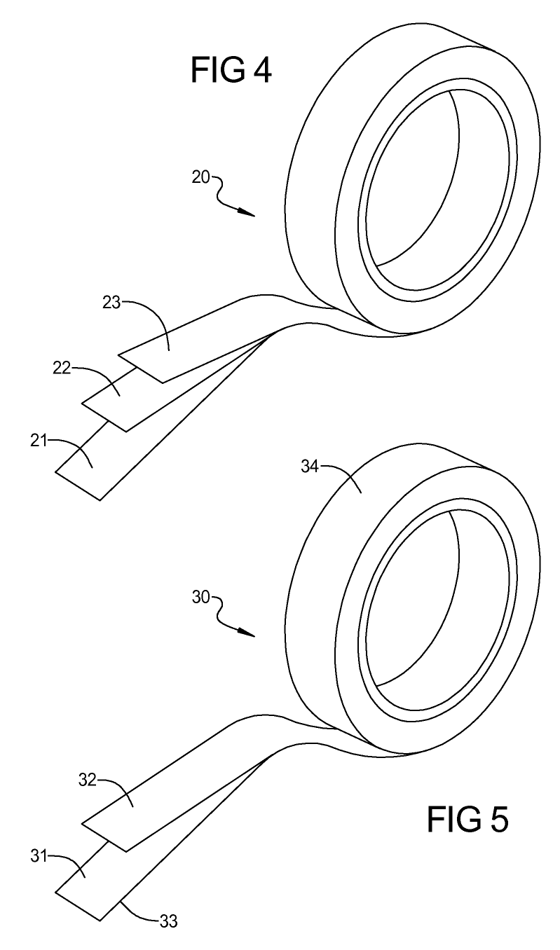

With reference to FIG. 2, there is illustrated how the HDPE or HMWHDPE tape or film 21 or 31 (for example, in accordance with the embodiments 20 and 30 disclosed in FIG. 4 or 5, respectively) bonds with an acrylic or rubber based adhesive layer 22 or 32, respectively, to the surface 10.

FIG. 3 illustrates that noise is eliminated with the HDPE or HMWHDPE tape 21 or 31 in place when the surfaces 10 and 11 are urged into contact with one another.

The embodiment 20 depicted in FIG. 4 comprises an HDPE or HMWHDPE anti-squeak tape with a release liner.

Embodiment 20 includes a HDPE or HMWHDPE tape or film 21, an acrylic adhesive layer 22, and a release liner 23.

The embodiment 30 illustrated in FIG. 5 comprises a self-wound HDPE or HMWHDPE anti-squeak tape.

Embodiment 30 includes a HDPE or HMWHDPE tape or film 31 having a release coating 33 thereon, and an acrylic or rubber based adhesive layer 32.

The release coating 33 coats the surface 34 shown in FIG. 5.

It should be noted that the HDPE or HMWHDPE film can be supplied plain, without any release coating, or, with a silicone release coating 33 on one side.

The silicone release may be coated on the HDPE or HMWHDPE film prior to applying the adhesive to the opposite side.

The silicone may be coated and then cured by either UV (ultraviolet) or EB (electron beam) methods, essentially permanently locking the silicone to the surface of the film.

The silicon coating allows the film to be self-wound after the adhesive has been coated to the opposite side, as adhesive will not adhere to silicone.

If the film is obtained plain (no silicone), then it is necessary to introduce a silicone coated release liner to roll it up. Typically this method is preferable when the film is to be die cut in various shapes, or a release coating on the top is not desirable.

The present invention provides it in both formats for different types of applications on the assembly line or process.

There have been illustrated in the accompanying drawings and described hereinabove only several of the unique and novel embodiments of the present invention which can be practiced and constructed in many different configurations, arrangements of components, sizes, and shapes.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and the patent claims set forth hereinbelow.

1. An anti-squeak tape, comprising:
a first film layer comprising a polyethylene material; and
a second film layer comprising an acrylic or rubber based adhesive material.

2. An anti-squeak tape according to claim 1, wherein:
said first film layer comprises a HMWHDPE material

3. An anti-squeak tape according to claim 1, wherein:
said first film layer comprises a HDPE material.

4. An anti-squeak tape according to claim 1, including:
a third film layer comprising a release liner; and
said second film layer is disposed between said first film layer and said third film layer.

5. An anti-squeak tape according to claim 2, including:
a third film layer comprising a release liner; and
said second film layer is disposed between said first film layer and said third film layer.

6. An anti-squeak tape according to claim 3, including:
a third film layer comprising a release liner; and
said second film layer is disposed between said first film layer and said third film layer.

7. An anti-squeak tape according to claim 2, wherein:
said first film layer comprises a HMWHDPE material having a specific density of about 0.947 g/cc³ or higher.

8. An anti-squeak tape according to claim 5, wherein:
said first film layer comprises a HMWHDPE material having a specific density of about 0.947 g/cc³ or higher

9. An anti-squeak tape according to claim 2, wherein:
said first film layer comprises a HMWHDPE material having a specific density of about 0.947 g/cc³ or higher

10. An anti-squeak tape according to claim 5, wherein:
said first film layer comprises a HMWHDPE material having a specific density of about 0.947 g/cc³ or higher

11. An anti-squeak tape according to claim 7, wherein:
said first film layer comprises a HMWHDPE material having a specific density of about 0.947 g/cc³ or higher

12. An anti-squeak tape according to claim 8, wherein:
said first film layer comprises a HMWHDPE material having a specific density of about 0.947 g/cc³ or higher

13. An anti-squeak tape according to claim 1, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

14. An anti-squeak tape according to claim 2, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

15. An anti-squeak tape according to claim 3, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

16. An anti-squeak tape according to claim 4, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

17. An anti-squeak tape according to claim 5, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

18. An anti-squeak tape according to claim 6, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

19. An anti-squeak tape according to claim 7, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.

20. An anti-squeak tape according to claim 12, including in combination:
a first external component having a first mating surface;
a second external component having a second mating surface;
wherein squeaks and/or other noise are generated when said first and second mating surfaces come into direct contact with each other; and
said anti-squeak tape is disposed between said first and second mating surfaces to prevent generation of such squeaks and/or noise.
